(19) United States
(12) Patent Application Publication
(10) Pub. No.: US 2017/0300559 A1
(43) Pub. Date: Oct. 19, 2017

(54) Systems and Methods for Facilitating Data Entry into Electronic Devices

(71) Applicant: Farzan Fallah, San Jose, CA (US)

(72) Inventor: Farzan Fallah, San Jose, CA (US)

(21) Appl. No.: 15/488,653

(22) Filed: Apr. 17, 2017

Related U.S. Application Data
(60) Provisional application No. 62/323,793, filed on Apr. 18, 2016.
(60) Provisional application No. 62/340,872, filed on May 24, 2016.
(60) Provisional application No. 62/373,107, filed on Aug. 10, 2016.

(51) Int. Cl. G06F 17/30; G06F 3/0484; G06F 3/0488

(52) U.S. Cl. CPC G06F 17/30643; G06F 17/30696; G06F 3/04842; G06F 3/04886

(57) ABSTRACT

An electronic device configured to facilitate data entry comprises a processor; a display, a database of n-grams; and an input device. In response to receiving as input into the input device a sequence of M letters, each corresponding to the first letter of a word, where M>=2, the processor extracts from the n-gram database one or more sequences of M words, each word in each sequence beginning with a corresponding one of the M input letters, and displays the one or more sequences of M words. In response to a selection being made from the displayed sequences of a sequence of K words starting at the beginning of one of the sequences of M words, where K<=M, the processor replaces the first K letters of the M letters by the selected sequence of K words and accepts the selected sequence of words as desired data entry.

### CROSS REFERENCE TO RELATED APPLICATION

This application claims priority to U.S. provisional application 62/323,793 filed on Apr. 18, 2016, U.S. provisional application 62/340,872 filed on May 24, 2016, and U.S. provisional application 62/373,107 filed on Aug. 10, 2016, each of which is hereby incorporated by reference, as if set forth in full in this specification

### FIELD OF THE INVENTION

Various embodiments of the invention described herein relate generally to the field of date entry into electronic devices, and in particular to systems and methods that facilitate data entry by reducing the time and effort required of the user of such devices.

### BACKGROUND OF THE INVENTION

Fast and accurate input of data in the form of textual or symbolic characters into digital electronic devices is of great interest and value in the field of human-computer interaction. In current practice, keyboards are the default option for data input devices, and are often satisfactory for relatively large electronic devices such as desktop and laptop computers, but the size constraints of devices such as tablets and smartphones makes even virtual (as opposed to physical) keyboards less than ideal. One major constraint is that because of the small screen size of these devices, the size of keys of their keyboards is small. Additionally, since these devices are usually held with hands, it is not possible to use all fingers to type. Some users hold these devices in one hand and use their index finger to type characters one by one. Other users might hold the device with their two hands and use their two thumbs to type. This generally lowers the typing speed when compared with, for example, a physical keyboard of a desktop computer.

Some word prediction (word suggestion) technologies have been developed to address this problem. These existing approaches typically operate such that when the user starts to type a word, several possible words based on the first few characters typed and/or on the previous word or words typed are displayed on the screen. The user can then select one of the displayed words, or, if none are what the user intended, the user can continue typing until a correct suggestion is displayed (and then selected) or the entire word is typed.

However, such approaches require the user to switch back and forth between viewing the suggested words and typing the actual words after each character is typed. This is obviously cumbersome and time-consuming.

For example, consider the case of a prior art electronic device operating as illustrated by FIGS. 1, 2, and 3, where the user intends to ultimately type “Thank you”. She begins (FIG. 1) by typing the letter “T” into a keyboard and the electronic device processor responds by suggesting five possible words all beginning with that letter. The user then has to pause to look at those words, finds that none of them is the one intended, and then types in the second letter “h” (FIG. 2). This time, the second word in the sequence offered by the electronic device is the correct word, so the user could select that word, and then begin typing in the second desired word. In the absence of the word prediction electronic device, the user could type the entire phrase “Thank you” quickly and without much conscious thought because she is familiar with the location of each letter of “Thank you” on the keyboard. The goal of the prior art prediction system or method is to make the process even faster. However, this requires the user to break into the well-known typing sequence by pausing after the first letter input and then the second, to review the suggestions, then press the second word suggested, and then to input “y” (FIG. 3), pause to review the new selections, and then press the first word suggested. This takes significant time and effort.

To make things even more complicated, many algorithms change the order of suggested words based on the previous words entered by the user and other factors. Thus, it is possible that the next time the user wants to enter “Thank you”, the word “you” will be the second suggested word, not the first one. Thus, the user can't develop muscle memory, knowing where a particular word such as “you” will be positioned, but has to look at each suggested word to find the word she wants to enter.

There is therefore a need for methods and systems that predict or suggest words in ways that speed up data entry in a more convenient manner for the user. Such methods and systems would ideally greatly reduce the frequency at which the user is required to switch attention back and forth between typing characters and selecting the desired word or words. It would also be beneficial for such methods and systems to accumulate knowledge of the user's habitual vocabulary to improve the prediction accuracy

### SUMMARY OF THE INVENTION

Embodiments generally relate to systems and methods for enhanced data entry into electronic devices. In one embodiment, an electronic device configured to facilitate data entry comprises a processor, a display, a database of n-grams and an input device wherein in response to receiving as input into the input device a sequence of M letters, where M is greater than or equal to 2, and each of the M letters corresponding to the first letter of a word, the processor extracts from the n-gram database one or more sequences of M words, each of the M words in each sequence beginning with a corresponding one of the M input letters, and displays the one or more sequences of M words on the display; and wherein in response to a selection, from the displayed sequences, of a sequence of K words starting at the beginning of one of the sequences of M words, where K is less than or equal to M, the processor replaces the first K letters of the sequence of M letters by the selected sequence of K words, the selected sequence of K words is accepted as desired data entry into the electronic device.

In another embodiment, a method of facilitating data entry comprises: receiving textual input comprising a sequence of M letters, where M is greater than or equal to 2, and each of the M letters corresponds to the first letter of a word; in response to the textual input, extracting from an n-gram database one or more sequences of M words, each of the words in each sequence beginning with a corresponding one of the M input letters; displaying the one or more extracted sequences of M words on the display; and in response to a selection of a sequence of K words starting at the beginning of one of the sequences of M words, where K is less than or equal to M, replacing the first K letters of the sequence of M letters by the selected sequence of K words, and accepting the selected sequence of K words as desired data entry from the user.

In another embodiment, a method of facilitating data entry comprises: receiving textual input, either using a first data entry method wherein the textual input comprises a sequence of M letters, where M is greater than or equal to 2, and each of the M letters corresponds to the first letter of a word; or using a second data entry method wherein the textual input comprises one or more letters that begin a single word; or both; in response to textual input using the first data entry method, extracting from an n-gram database one or more sequences of words, each of the words in each sequence beginning with a corresponding one of the M input letters, displaying the extracted sequences to the user, and, in response to a selection of a sequence of M words, accepting the selected sequence of M words as desired data entry; and in response to textual input using the second data entry method, extracting from a word database one or more words starting with the one or more letters input using the second data entry method, displaying the extracted one or more words, and, in response to a selection of one of the one or more displayed words, accepting the selected word as desired data entry.

### BRIEF DESCRIPTION OF THE DRAWINGS

FIG. 1 (prior art) depicts a portion of a virtual keyboard after a user has input the first letter of a first word.

FIG. 2 (prior art) depicts the virtual keyboard of FIG. 1 after the user has input the second letter of the first word.

FIG. 3 (prior art) depicts the virtual keyboard of FIGS. 1 and 2 after the user has selected the first word and input a first letter of a second word.

FIG. 4 depicts an electronic device according to one embodiment of the present invention.

FIG. 5 depicts a virtual keyboard in use according to one embodiment of the present invention.

FIG. 6 depicts a later stage of use of the virtual keyboard according to the embodiment of FIG. 5.

FIG. 7 depicts another later stage of use of the virtual keyboard according to the embodiment of FIG. 5.

FIG. 8 depicts the use of a virtual keyboard according to one embodiment of the present invention.

FIG. 9 depicts a later stage of use of the virtual keyboard according to the embodiment of FIG. 8.

FIG. 10 depicts a bigram table stored in a database according to one embodiment of the present invention.

FIG. 11 depicts a trigram table stored in a database according to one embodiment of the present invention.

FIG. 12 depicts the use of a virtual keyboard and an n-gram table according to one embodiment of the present invention.

FIG. 13 depicts the use of a virtual keyboard and an n-gram table according to one embodiment of the present invention.

FIG. 14 depicts the use of a virtual keyboard according to one embodiment of the present invention.

FIG. 15 depicts the use of a virtual keyboard according to one embodiment of the present invention.

FIG. 16 depicts the use of a virtual keyboard according to one embodiment of the present invention.

FIG. 17 depicts the use of a virtual keyboard according to one embodiment of the present invention.

FIG. 18 depicts the use of a virtual keyboard according to one embodiment of the present invention.

FIG. 19 depicts the use of a virtual keyboard according to one embodiment of the present invention.

FIG. 20 depicts the use of a virtual keyboard according to one embodiment of the present invention.

FIG. 21 depicts the use of a virtual keyboard according to one embodiment of the present invention.

FIG. 22 depicts the use of a virtual keyboard according to one embodiment of the present invention.

FIG. 23 depicts the use of a virtual keyboard according to one embodiment of the present invention.

FIG. 24 depicts the use of a virtual keyboard according to one embodiment of the present invention.

FIG. 25 depicts the use of a virtual keyboard according to one embodiment of the present invention.

FIG. 26 depicts the use of a virtual keyboard according to one embodiment of the present invention.

FIG. 27 depicts the use of a virtual keyboard according to one embodiment of the present invention.

FIG. 28 depicts the use of a virtual keyboard according to one embodiment of the present invention.

FIG. 29 depicts the use of a virtual keyboard according to one embodiment of the present invention.

FIG. 30 depicts the use of a virtual keyboard according to one embodiment of the present invention.

FIG. 31 depicts the use of a virtual keyboard according to one embodiment of the present invention.

FIG. 32 depicts the use of a virtual keyboard according to one embodiment of the present invention.

FIG. 33 depicts the use of a virtual keyboard according to one embodiment of the present invention.

FIG. 34 depicts the use of a virtual keyboard according to one embodiment of the present invention.

FIG. 35 depicts the use of a virtual keyboard according to one embodiment of the present invention.

FIG. 36 depicts the use of a virtual keyboard according to one embodiment of the present invention.

FIG. 37 depicts the use of a virtual keyboard according to one embodiment of the present invention.

FIG. 38 depicts the use of a virtual keyboard according to one embodiment of the present invention.

FIG. 39 depicts the use of a virtual keyboard according to one embodiment of the present invention.

FIG. 40 depicts the use of a virtual keyboard according to one embodiment of the present invention.

FIG. 41 depicts the use of a virtual keyboard according to one embodiment of the present invention.

FIG. 42 depicts the use of a virtual keyboard according to one embodiment of the present invention.

FIG. 43 depicts the use of a virtual keyboard according to one embodiment of the present invention.

FIG. 44 depicts the use of a virtual keyboard according to one embodiment of the present invention.

FIG. 45 depicts the word sequences used to conjugate verbs in English language, that may be stored in n-gram tables in an n-gram database according to one embodiment of the present invention.

FIG. 46 depicts the use of a virtual keyboard and an interface to add sentences and sequences of words to the database according to one embodiment of the present invention.

FIG. 47 depicts the use of an interface to flag incorrect entries according to one embodiment of the present invention.

FIG. 48 depicts the use of an interface to choose what entries download to the database according to one embodiment of the present invention.

FIG. 49 (prior art) depicts the rules for entering Japanese Hiragana characters using English letters.

FIG. 50 (prior art) depicts the rules for entering Japanese Katakana characters using English letters.

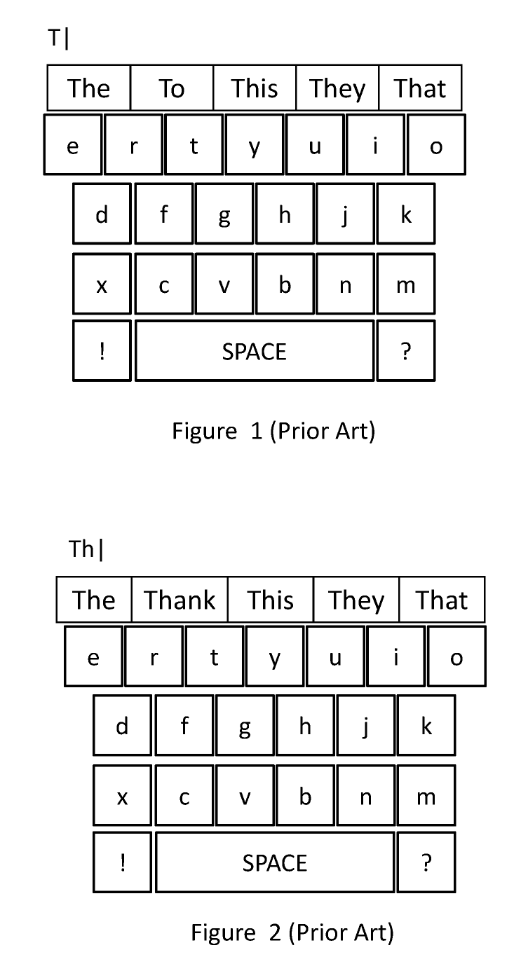

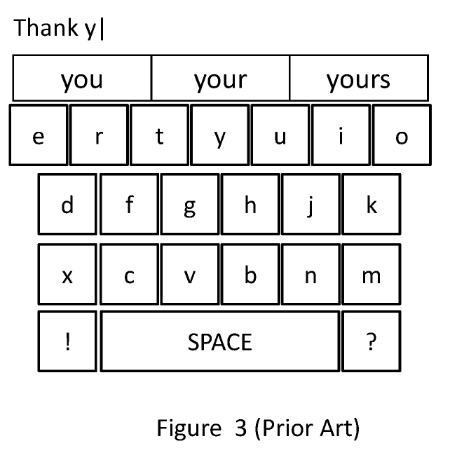

### DETAILED DESCRIPTION

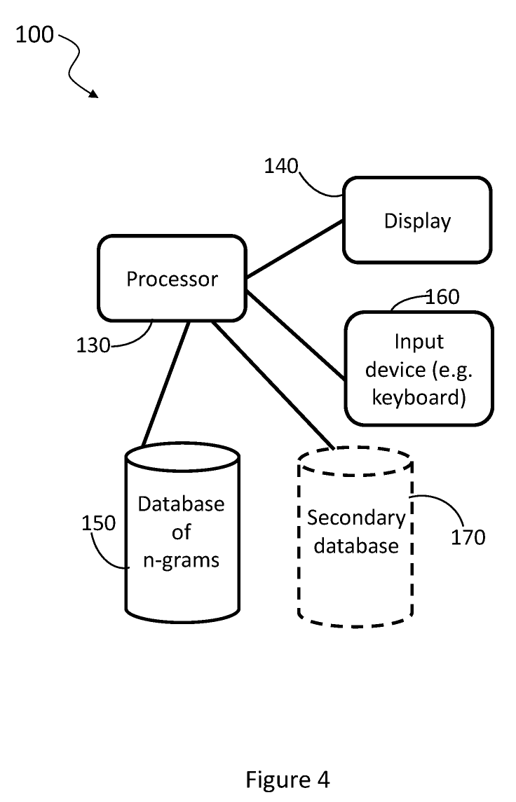

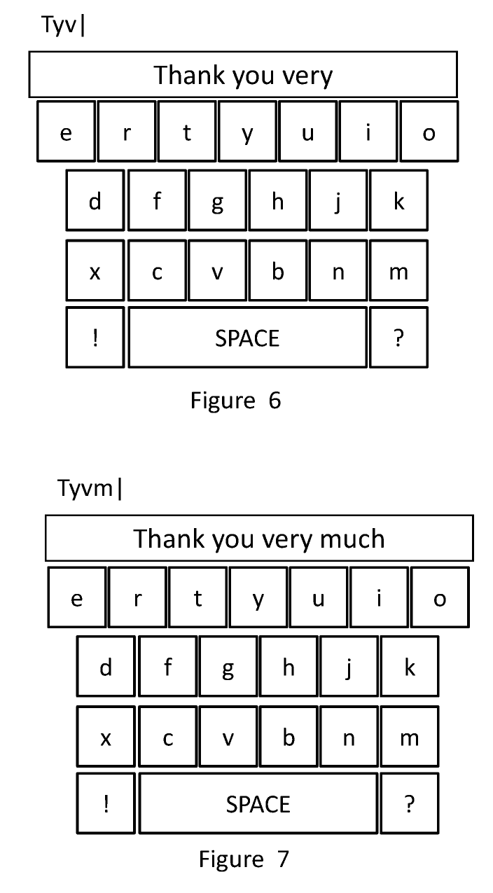

The manner in which the present invention provides its advantages can be more easily understood by referring to FIGS. 4 through 50.

FIG. 4 depicts electronic device 100 according to some embodiments of the present invention. Electronic device 100 comprises processor 130 operably connected to display 140, database of n-grams 150, and input device 160, which may be a physical or virtual keyboard, a keypad, a TV remote control, a handwriting recognition unit, etc. Throughout the following description, the word keyboard is generally used, for convenience, but in many cases, other input devices well known in the field could be used in a similar way. In some embodiments, electronic device 100 also includes secondary database 170.

For the entirety of this disclosure, the term “n-gram” is defined as a sequence of n adjacent words, so a database of n-grams should be understood as containing organized tables or listings of such sequences. The n-grams are usually generated from a piece of text or speech. For each n-gram the number of times it appears in the text or speech can be recorded in the n-gram table as the occurrence frequency of the n-gram. N-grams of different length (e.g., sequence of two words and three words) can be stored in separate tables or in a single table.

It should also be noted that in this disclosure the noun “input” is used to refer to data (letters or words) input by a user into the input device, where the data are indicative of the data that the user wishes to be ultimately entered into the device, this ultimate or intended data being referred to by the terms “data entry” or “desired data entry”.

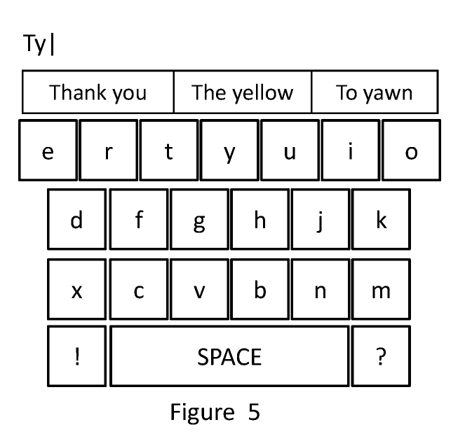

FIGS. 5, 6 and 7 illustrate some embodiments of the present invention, in which the user inputs n letters (or characters) into an input device, in this case a virtual keyboard of the electronic device, such that each letter is the first letter of one of the n words that she wants to enter. The electronic device processor operates to extract from a database of n-grams and then to display one or more sequences, each sequence having n words, such that the i-th word starts with the i-th letter the user has entered, where 0<=i<n. The user can select one of the sequences to enter its words. In some embodiments, the suggested words are selected by the processor from words stored within a secondary database or dictionary (such as element 170 shown in FIG. 4). In some embodiments, the frequency of the occurrence of the sequence of words is taken into account by the processor in choosing which words to extract and display.

In some embodiments, after a user inputs a sequence of M letters, where M is greater than or equal to 2, and each of the M letters corresponding to the first letter of a word, and after the processor extracts from the n-gram database one or more sequences of M words, each of the M words in each sequence beginning with a corresponding one of the M input letters, and displays the one or more sequences of M words on the display, the user may select one of the sequences of M words. In response to that selection, the processor replaces the M letters with the selected sequence of M words, and accepts the selected sequence of M words as desired data entry.

In some other embodiments, after a user inputs a sequence of M letters, where M is greater than or equal to 2, and each of the M letters corresponding to the first letter of a word, and after the processor extracts from the n-gram database one or more sequences of M words, each of the M words in each sequence beginning with a corresponding one of the M input letters, and displays the one or more sequences of M words on the display, the user may select only the first K words of one of the sequences, where K<M, so selecting a sequence of K words. In response to that selection, the processor replaces the first K letters of the sequence of M letters by the selected sequence of K words, and accepts the selected sequence of K words as desired data entry.

It is possible that a user inputs the first letters of multiple words and the electronic device processor suggests several word sequences, but none of them is what the user wants to enter. In this case, the user will want to use the input device just like a regular keyboard. In such cases, there is a need for a method to quickly erase the letters.

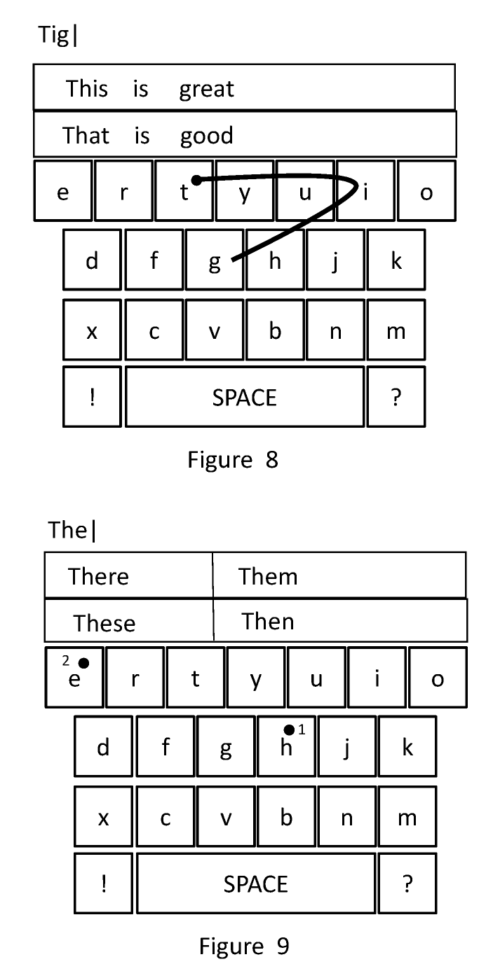

In some embodiments, the electronic device has a virtual keyboard and supports a gesture based data entry method, such as Swype™. Thus, the user can enter letters by moving her finger on the keys of the virtual keyboard and the electronic device processor finds the letters the user has entered based on the beginning and the end points of the gesture, the shape of the gesture, the direction of the finger movement, the length of time the user paused on some keys and possibly a database of valid sequences of letters. If the user inputs the letters by using the gesture based method, the electronic device processor suggests one or more sequences of words. If the user does not select any of the sequences of words or a part of the sequences, and the user starts inputting letters using regular typing (i.e., by pressing the keys of the keyboard), this indicates that the user wants to enter words one by one. Thus, the electronic device processor erases the previously input letters and replaces them with the newly input letters and displays one or more words corresponding to the input letters. In FIG. 8, the user has put her finger on key “t” and moved her finger to “i” and “g” and then lifted her finger, thus, inputting “tig”. The electronic device processor has displayed two sequences of words corresponding to “tig”. Assuming the user wanted to enter “There is green”, none of the suggestions is what she wanted to enter. Thus, the user starts typing letters by pressing keys of the keyboard (FIG. 9). The user inputs “h”, and “e”, thus, the electronic device processor erases all but the first inputted letters (i.e., “T”) and inputs “h” and “e” after that, and suggests several completions for “The”. Since the user has already input the first letter of the first word, there is no need to re-input it when entering the first word, letter by letter. In some embodiments, instead of erasing all the letters, all except the first letter is erased. In some embodiments, when the user erases some letters by starting using a different data entry method or by pressing a special button, the erased letters are recorded in the memory and are used when suggesting words to the user. In the example of FIGS. 8 and 9, the user has erased “ig”. When she enters the first word by for example selecting “There”, the electronic device processor suggests one or more words starting with “i”. After entering the second word, the electronic device processor suggests one or more words starting with “g”.

In some embodiments, the electronic device includes a swipe recognition device operatively connected to the processor and display such that a swipe gesture deletes all input letters except the first letter of the input sequence. Note that the word “swipe” is defined for the entirety of this disclosure as having its standard meaning in the context of touchscreen devices, the noun form being the act of moving one's finger across a touchscreen to activate a function.

If the user has entered some letters to use a multi-word suggestion method (a method according to one embodiment of this invention that suggests a sequence of words, as described later in this disclosure), but the electronic device processor fails to suggest what the user wants to enter, the above embodiment which has two different methods of data entry, allows the user to quickly erase the letters and start entering words one by one by just starting using a second data entry method.

Methods of data entry according to embodiments of the present invention reduce the number of times that the user must switch between the keyboard and the list of suggested sequence of words. The user inputs n letters and looks at the list once to see if the suggested sequences of words include the sequence of words she wanted to enter.

Additionally, since the prediction algorithm has information about multiple words that the user wants to enter, it can use the information to better predict the words. For example, when using current prediction algorithms, if a user wants to type “Thank you” and inputs “T”, the electronic device processor might suggest “The”, “This”, “They”, and “That” as the next word. If she inputs the second letter (i.e., “h”), the electronic device processor will suggest the same words as before. After the user inputs the third letter (i.e., “a”), the electronic device processor might suggest “Thank”. But, when using this invention, if the user inputs “Ty” corresponding to the first letters of the first and the second words, the electronic device processor might correctly predict “Thank you” as the words the user wants to enter because “Thank you” has a higher occurrence frequency compared to any other sequence of two words which have the same first letters (e.g., “The yellow”, “To yawn”, “That yogurt”).

To help users to remember some of the sequences that are correctly predicted by the electronic device processor, some sequences that have special properties are used. Thus, in some embodiments, the sequences of words used for conjugating verbs are added to the electronic device. In some embodiments, the sequences of words recently used in the text written or read/viewed by the user are used. This is useful because if for example, a user has received a message which includes “driver test”, it is likely that his reply will include “driver test”. This embodiment allows the user to input “dt” to enter “driver test”.

As another strategy, to reduce the mis-prediction rate of the electronic device (i.e., the likelihood that what the user intends to enter is not among the sequences suggested by the electronic device processor), a set of n-grams with high occurrence frequency is used.

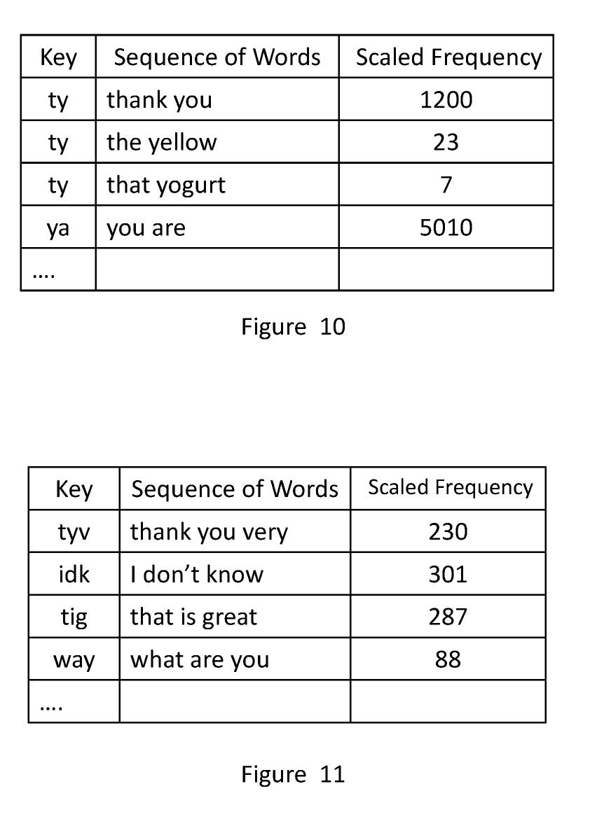

FIGS. 10 and 11 illustrate embodiments in which database 150 includes a table of n-grams with the occurrence frequency for each n-gram and a key associated with each entry. The key is an n-letter sequence such that the i-th letter is the first letter of the i-th word in the sequence of words of that entry, where 0<=i<n.

In some embodiments, the table does not include the frequency occurrence. In some embodiments, the table does not include the frequency occurrence but the entries are sorted based on their frequencies.

When the user inputs a sequence of n letters, the electronic device processor searches the table to find entries whose key matches the sequence of n letters input by the user and selects k of these entries with highest occurrence frequency, where k>=1. The electronic device displays the n-grams corresponding to these k entries to the user as the list of suggested sequences of words. In some embodiments, k=1.

In some embodiments, multiple n-gram tables are used such that n has different values. For example, n-gram database 150 might have 4 tables, one for storing bigrams (n=2), one for storing trigrams (n=3), one for storing 4-grams and one for storing 5-grams.

In some of the embodiments in which n-gram database 150 has multiple tables, if the user has input n letters and there is no entry in the n-gram table whose key is equal to the input n letters, the electronic device processor uses the first k letters input by the user to construct a key and searches the k-gram table to find one or more entries corresponding to that key, where 2<=k<n. In some embodiments, k=n−1.

For example, consider the bigram and trigram tables of FIGS. 10 and 11, respectively. Assume the user inputs “tys”. There is no entry whose key is “tys” in the trigram table. Thus, the electronic device processor searches the bigram table for “ty” and finds an entry whose key is “ty” (i.e., “thank you”).

In some embodiments, if the user has input n letters and there is no entry in the n-gram table whose key is equal to the input n letters, the electronic device processor searches the table for entries whose keys matches with the input letters in the first k positions, where 1<=k<n, and chooses one or more of these entries and displays them to the user. In some embodiments, only the first k words of entries are displayed. In some embodiments, k=n−1.

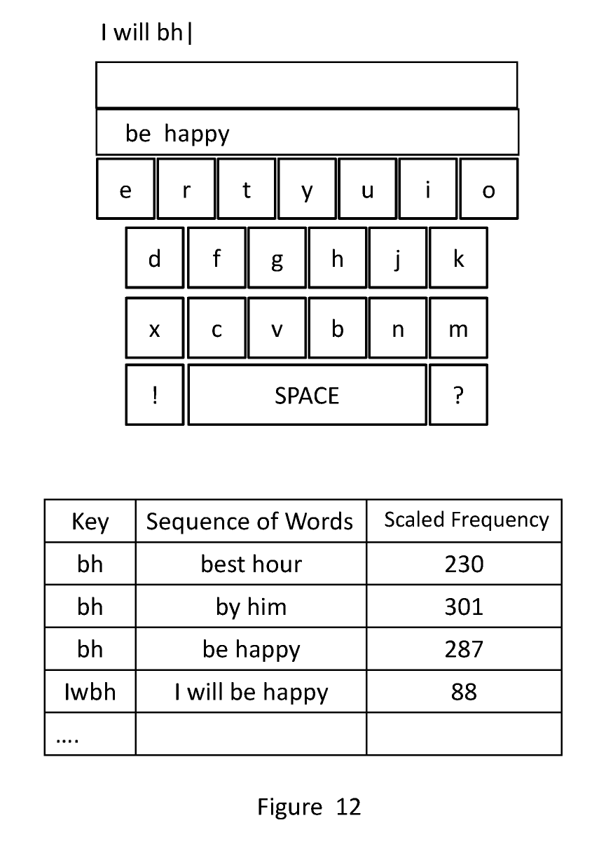

In some embodiments, after the user has entered some words, the user inputs k letters. The electronic device processor chooses the last (n-k) words input and constructs a sequence of (n-k) letters from the first letters of the words. It then concatenates the input k letters to the end of this constructed sequence of letters to construct an n-letter sequence and uses this sequence as the key to search the entries of the n-gram table and finds entries whose first (n-k) words is the same as the sequence of the last (n-k) words entered by the user. The electronic device processor then displays the last k words of these sequences of words to the user. If the user selects one of these sequences, the processor accepts the selected sequence of words as the desired data entry—In FIG. 12, the user has entered two words “I will”. Then she has inputted letters “bh”. The n-gram table which has bigrams, trigrams, and 4-grams entries, has multiple entries that have “bh” as their key (e.g., “best hour”, “by him”, “be happy”). The electronic device processor uses already entered words (i.e., “I will”) to improve the sequences that it suggests (i.e., to suggest sequences that are more likely to be what the user intends to enter). The n-gram table does not have any entry for “I will best hour” or “I will by him”, but it has an entry for “I will be happy”. Thus, the electronic device displays “be happy” as a suggestion to the user. If the entry “I will be happy” did not exist, the electronic device processor could search the n-gram table for “will best hour”, “will by him” and “will be happy”.

In some embodiments, after the user has entered some words, the user inputs k letters. The electronic device processor searches the n-gram tables to find some sequences of words for the inputted letters and it uses the already entered words to select some of the sequences or rank the sequences and display the top ranked sequences. In some embodiments, a sequence S is selected only if there is at least one entry in the n-gram tables that has the sequence of words, S′, constructed by taking the last (n-I) already entered words and the first I words of sequence S, where 1<=I<=k and (n-I)>=1. In some embodiments, the frequency of sequence S′ is used to decide what sequence S to suggest or how to rank sequences. In some embodiments, all sequences S′ corresponding to S are found and their frequencies are used to decide whether to suggest S or are used to rank it. For example, it is possible to sum all the frequencies and use the result to rank suggestion S.

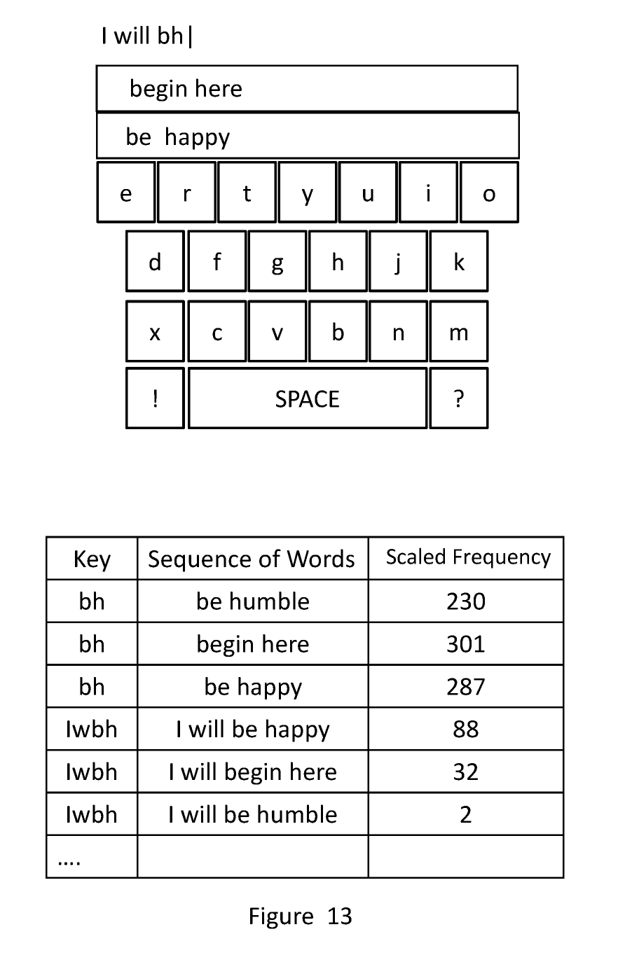

In FIG. 13, the user has entered two words “I will”. Then she has inputted letters “bh”. The n-gram table which has bigrams, trigrams, 4-grams entries, has multiple entries that have “bh” as their key (e.g., “begin here”, “be humble”, “be happy”). The electronic device processor uses already entered words (i.e., “I will”) to improve the sequences that it suggests. The n-gram table has entries for “I will begin here”, “I will be humble”, and “I will be happy”. Thus, the electronic device processor uses their frequencies and chooses and displays “be happy” and “begin here” as suggestions to the user.

In some embodiments, the electronic device stores the text the user has typed or the user has read (e.g., the messages she has received) and uses them to construct one or more n-gram tables (e.g., a table of bigrams and a table of trigrams). When the user inputs multiple letters the electronic device processor searches these tables in addition to other n-gram tables to find candidates for word sequences. In some embodiments, the electronic device processor stores some data such as how many times and how recently (i.e., the date and the time) the user has used a given sequence (i.e., a given n-gram) and uses these data when constructing the list of suggested sequences of words. For example, if a sequence of words has been used a few minutes ago, if it is in the list of sequences suggested by the electronic device, it will be displayed before a sequence which has never been used by the user before.

In some embodiments, the electronic device processor may be used to search an address book. Each entry in the n-gram table corresponds to a name of a person in the address book. For example, there may be an entry corresponding to “John Smith” such that its key is “js”. If the user inputs “js” the electronic device processor suggests “John Smith”. In some embodiments, the electronic device processor may be used to search the TV guide for a program, an actor, a director, a channel name, or searches the synopsis or closed caption text of a program.

In some embodiments, the electronic device processor may be used to search a given text. The user inputs the first letters of words that she wants to search. The electronic device processor finds, extracts and displays one or more sequences of words in the given text that have the same first letters as input by the user. In some embodiments, the electronic device processor builds one or more n-gram tables from a given text, such that each entry has a list of pointers to locations of the text where the sequence appears, and uses the one or more n-gram tables to search for one or more sequences of words and displays the locations of the text where the sequences appear.

In some embodiments, searching of the n-gram table (i.e. finding entries whose keys are the same as the input letters) is case-sensitive. In some embodiments, searching of the n-gram table is case-insensitive.

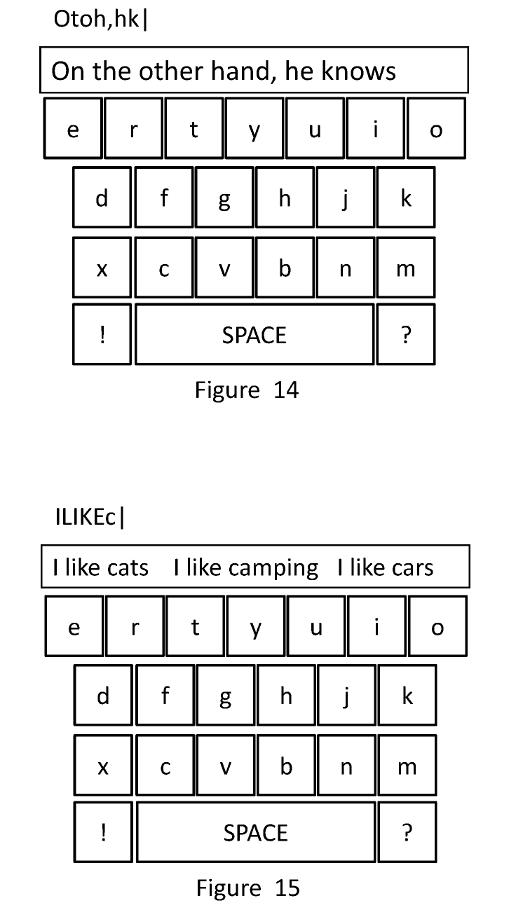

In some embodiments, the user may input some non-letter characters (e.g., punctuation marks) between some of the n letters. The electronic device processor removes the non-letter characters before finding the corresponding sequence of words. In some embodiments, like the one illustrated in FIG. 14, the electronic device processor inserts the non-letter characters between the displayed words and if the user selects the displayed words, it enters the selected words with the non-letter characters.

In some embodiments, if one of the letters is uppercase, after finding the sequence of words, the first letter of the word corresponding to the uppercase letter is capitalized. In some embodiments, if one of the letters is uppercase, after finding the sequence of words, all letters of the word corresponding to the uppercase letter are capitalized. In some embodiments, if before inputting one of the letters, the SHIFT key is pressed and locked and the letter is input and then the SHIFT key is unlocked, after finding the sequence of words, all letters of the word corresponding to that letter are capitalized.

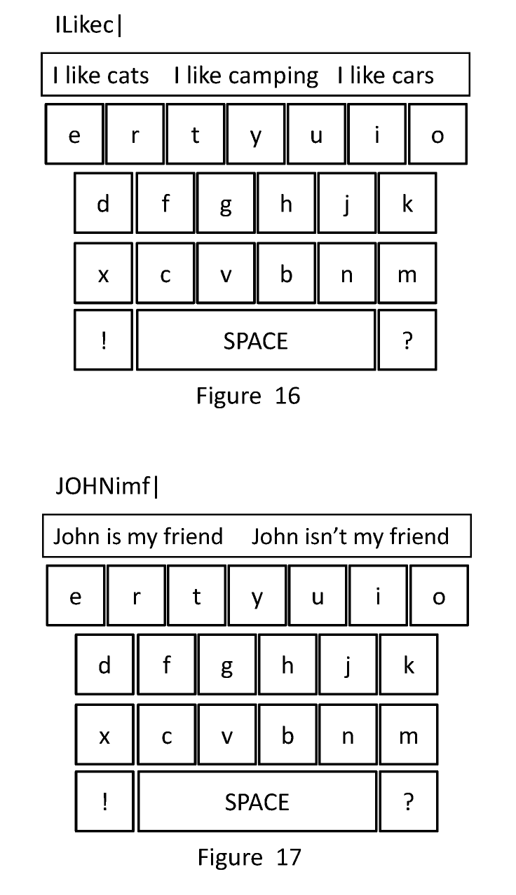

In some embodiments, the user may write one or more words in addition to n letters. The word might be indicated by writing its letters in uppercase, by inputting a specific punctuation (e.g., “&”) before and after the word, by pressing a meta key such as Ctrl or performing a gesture before and after the word to indicate the start and the end of the word. For example, the user inputs ILIKEc, the electronic device processor searches the table for the key “Ilc” and finds all entries whose second word is “like” (e.g., “I like cats”, “I like camping”). This is particularly useful if the user knows that there are many entries for the key “Ilc” and wants the electronic device to show only the entries whose second word is “like” (FIG. 15). In some embodiments, the user indicates only the beginning of the word and the electronic device processor chooses a sequence of letters such that the sequence is in the dictionary of the electronic device, and uses the sequence as the word. In the situation illustrated in FIG. 16, the user has indicated the start of or the first letter of the word. The electronic device processor searches and finds that “like” is in the dictionary, but “Ii”, “lik” and “likec” are not in the dictionary. Thus, the electronic device processor uses “like” as the word. Then, it constructs the string “Ilc” and uses it to find multi-word suggestions. In some embodiments, the sequence of letters selected as the word is the shortest possible sequence. In some embodiments, the sequence of letters is the longest possible sequence. In some embodiments, the sequence which results in the word with the highest frequency of occurrence, found using a secondary database or dictionary that has words with their occurrence frequencies is used. In some embodiments, the sequence which results in the multi-word suggestion with the highest frequency of occurrence is used. In some embodiments, all possible sequences which correspond to a valid word are considered.

In some embodiments, the word might be input by the user using a different method than the method used to input the letters (i.e., the first letter of words). E.g., the word might be input using a gesture-based technique, while the letters might be input by pressing keys of the keyboard, i.e. by standard keyboard typing.

In some embodiments, the user inputs a proper noun in addition to letters. The electronic device processor finds an appropriate pronoun for the proper noun, then replaces the proper noun with the first letter of the pronoun. After finding one or more sequences of words, the electronic device processor replaces the pronoun with the proper noun. For example, in FIG. 17, the user has input “JOHNimf”. The electronic device processor replaces “JOHN” with “H”, the first letter of pronoun “He”, then finds one or more multi-word suggestions for “Himf” such that their first word is “He” (e.g., “He is my friend” and “He isn't my friend”). Then it replaces “He” with “John” in the multi-word suggestions and displays them on the suggestion list or suggestion bar. If the electronic device processor searches the n-gram tables without replacing “JOHN” with “H” (i.e., searches the n-gram tables for “Jimf”, it is unlikely that it finds an entry and if there is one, it is unlikely that its corresponding sequence of words starts with “John”. Converting “John” with “He” and then using “H” to construct the key “Himf” increases the chance of finding a match. The match is then processed, “He” is replaced with “John” to construct a sequence of words that are likely what the user wants to enter. The suggestion bar can be scrollable. This can be specially useful on small devices such as smart watches. In some embodiments, the user inputs multiple nouns.

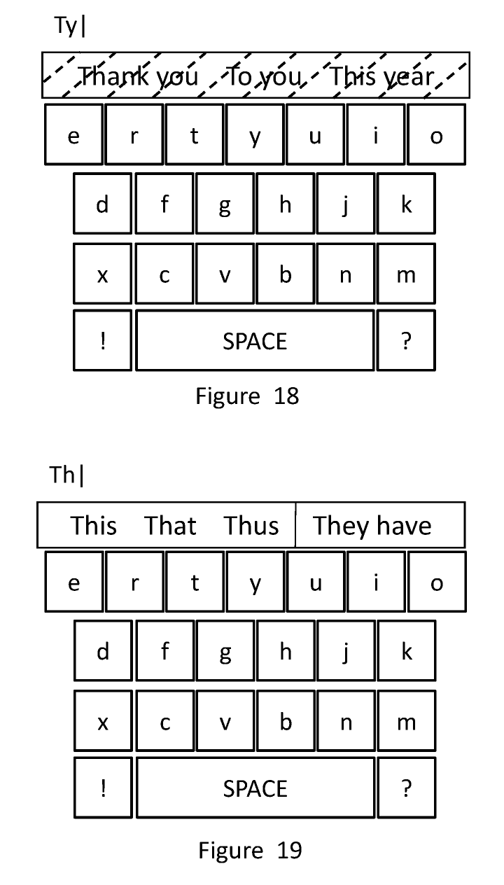

In some embodiments, if the user has input n letters and if there is at least one sequence of words corresponding to the letters, the electronic device displays one or more sequence of words corresponding to the n letters and an indicator that there is at least one sequence of words corresponding to the n letters. In some embodiments, the indicator is the background color of the suggestion bar where the sequence is shown. In some embodiments, the indicator is green background color. This allows the user to quickly (i.e., without reading the sequences) find if the electronic device processor has found one or more sequence of words corresponding to the n-letters or not. This is especially useful in embodiments that the electronic device displays a shorter sequence of words if it fails to find an n-word sequence. Thus, by changing the background color to green, the electronic device signals to the user, that she can input more letters. In FIG. 18, this is shown by using a dashed background.

In some embodiments, if the user has input n letters and there is no sequence of words corresponding to the n letters, the electronic device displays an indicator that there is no match. In some embodiments, the indicator is the background color of the suggestion bar. In some embodiments, the indicator is red background color. In some embodiments, if there is no match, one or more sequences of words corresponding to the first k letters input by the user are displayed, where 0<k<n. In some embodiments, k is the largest number for which there is a sequence. By for example, changing the background color to red, the electronic device signals to the user that she has to stop entering more letters.

In some embodiments, if the user has input n letters and there is at least one sequence of words corresponding to the letters, but there will be no sequence of words if one more letter is input, the electronic device displays one or more sequence of words corresponding to the n letters and an indicator that if the user types one more letter, there will be no sequence of words corresponding to the (n+1) letters. In some embodiments, the indicator is the background color of the suggestion bar. In some embodiments, the indicator is yellow background color. In some embodiments, the indicator is red background color.

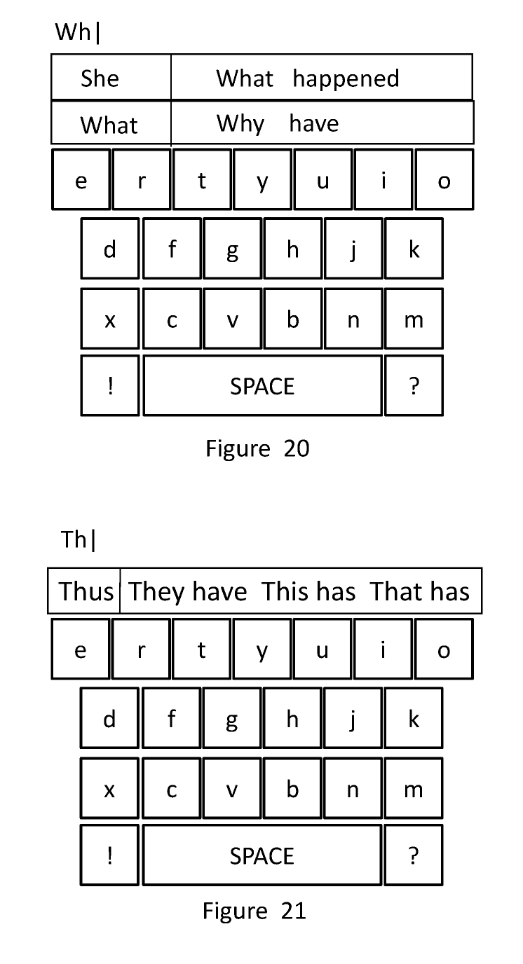

In some embodiments, as illustrated in FIG. 19, in addition to the sequences of words corresponding to the n letters input by the user, the electronic device displays one or more words, each word found using regular word prediction or word correction techniques (i.e., the electronic device processor assumes the n letters input by the user correspond to a single word and suggests one or more words, each word completing the input letters or correcting the input letters). This allows the user to use both this invention and the regular word suggestion without explicitly telling the electronic device whether the inputted letters correspond to one word or to multiple words. In FIG. 20, the user has inputted “Wh”. The electronic device processor has suggested “What” as a possible completion and “She” as a correction. The electronic device processor has also suggested two multi-words “What happened” and “Why have”.

Suggested words can be put into three categories: word correction, word completion, or multi-word suggestions.

In some embodiments, different categories are displayed in different regions on the word suggestion bar. In some embodiments, different categories are indicated using one or more of background color, font color, font size, font type or font style (e.g., bold, italic). In some embodiments, multi-word suggestions are generated if the user has input at least two letters. In some embodiments, if the user has input only two letters, multi-word suggestions are found by searching only the two-word messages or two-word sentences previously written or read/received by the user or the two-word sentences existing in the database. This is done to limit the number of two-word suggestions and make it easier for the user to use word-completion suggestions which are likely to be what the user wants to enter if she has input only two letters.

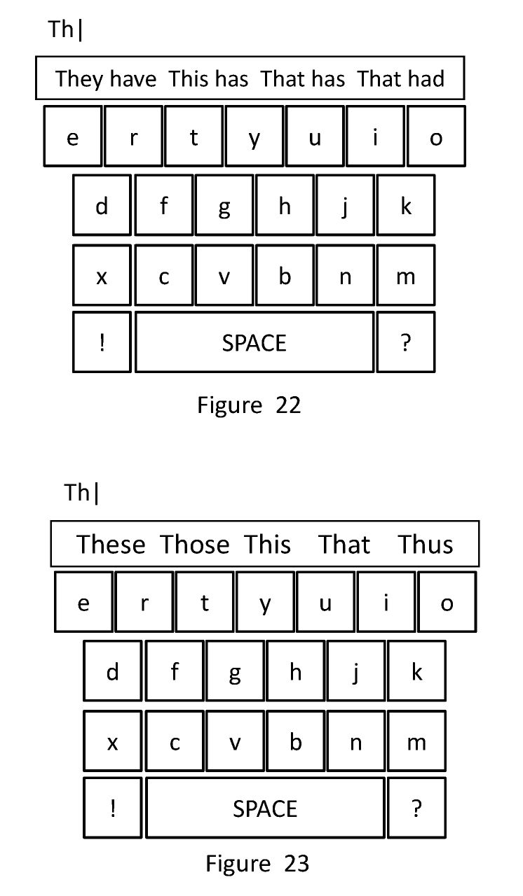

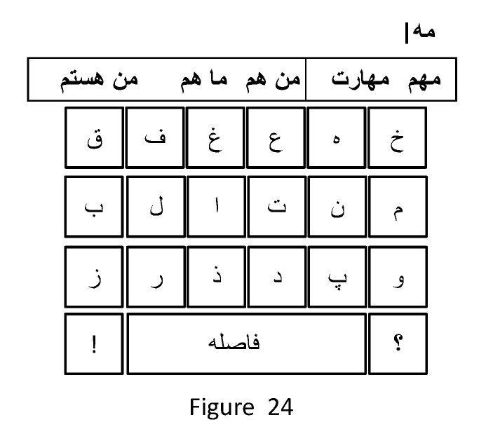

In some embodiments, multi-word suggestions are generated if the user has input at least three letters. In some embodiments, if in addition to multi-word suggestions, there is one or more word correction or word completion suggestions, the electronic device displays the middle of the scrollable suggestion bar such that the multi-word suggestions are displayed on one side of the scrollable bar and other suggestions are displayed on the other side of the bar. FIG. 21 shows one embodiment in which the suggestion bar is scrollable so the user can scroll it to see more suggestions. FIG. 19 and FIG. 22 show the suggestion bar scrolled right and left. Such embodiments allow the user easy and quick access to different types of suggestions. In contrast, if the scrollable suggestion bar is displayed from its beginning (as shown in FIG. 23), if the user wants to choose a multi-word suggestion, she has to scroll the suggestion bar to pass other suggestions until she sees the multi-word suggestions. These embodiments are especially useful for smartwatches that have small screens. Due to their size limitation, it is not possible to display all suggestions on the screen at the same time. These embodiments allow the user to quickly look at one set of suggestions or the other. In some embodiments, for a language such as English that the words are written from left to right, the multi-word suggestions are written at the right portion of the suggestion bar, to make it easier for the user to read them as she scrolls the bar from right to left (FIG. 19). In some embodiments, for a language such as Farsi in which the words are written from right to left, the multi-word suggestions are written at the left portion of the suggestion bar, to make it easier for the user to read them as she scrolls the bar from left to right. FIG. 24 illustrates one such embodiment.

In some embodiments, if the user has input only two letters, the multi-word suggestions are found and written on the suggestion bar, but the scrollable suggestion bar is set to a position, where they are not visible at the beginning. This makes it easier for the user to look at the word correction or word completion suggestions, which might be what the user finds useful as she has input only two letters. In other words, this makes multi-word suggestions less intrusive.

When predicting multiple words, in some cases, the electronic device processor correctly predicts the sequence of the words, but, for example, incorrectly predicts the tense of a verb existing in the sequence of words. For example, the processor might predict “She tries hard”, if the user has input “Sth”, while the user wants to enter “She tried hard”. Similarly, it is possible that the processor predicts “I can do that” while the user wants to enter “I could do that”, or predicts “There would be”, while the user wants to enter “There will be”. In these cases, the user will not be able to use the entire sequence of words. She can at best select a part of the sequence and then look at the new suggestions or possibly type more letters. Alternatively, the user can select the entire sequence but delete and change one or more words of it. Both require extra work (i.e., typing new letters, reading new suggestions) and take time.

Note that electronic devices typically suggest a small number of word sequences, for the practical reason that presenting a large number of suggestions would require the user to spend an undue amount of time going through all of them. Otherwise, both “She tries hard” and “She tried hard” could be suggested by the electronic device processor.

Similarly, if a user wants to enter a noun in the plural form, the electronic device processor might suggest it in the singular form (e.g., “Give my book back” instead of “Give my books back”). Again, in these cases, the user cannot use the entire sequence.

As another example, if a user wants to enter a verb in the negative form, the electronic device processor might suggest it in the positive form (e.g., “I will go” instead of “I won't go”). Or if a user wants to enter a verb in the positive form, the electronic device processor might suggest it in the negative form (e.g., “I won't go” instead of “I will go”).

In some embodiments, if the electronic device processor has suggested a verb in the past form, the user can long-press the suggestion or drag a finger on the suggestion to enter it in the present form. In some embodiments, if the electronic device processor has suggested a verb in the present form, the user can long-press the suggestion or drag a finger on the suggestion to enter it in the past form.

In some embodiments, if the electronic device processor has suggested a singular noun, the user can long-press the suggestion or drag a finger on the suggestion to enter it in the plural form. In some embodiments, if the electronic device processor has suggested a plural noun, the user can long-press the suggestion or drag a finger on the suggestion to enter it in the singular form.

In some embodiments, if the electronic device processor has suggested a verb in the positive form, the user can long-press the suggestion or drag a finger on the suggestion to enter it in the negative form. In some embodiments, if the electronic device processor has suggested a verb in the negative form, the user can long-press the suggestion or drag a finger on the suggestion to enter it in the positive form.

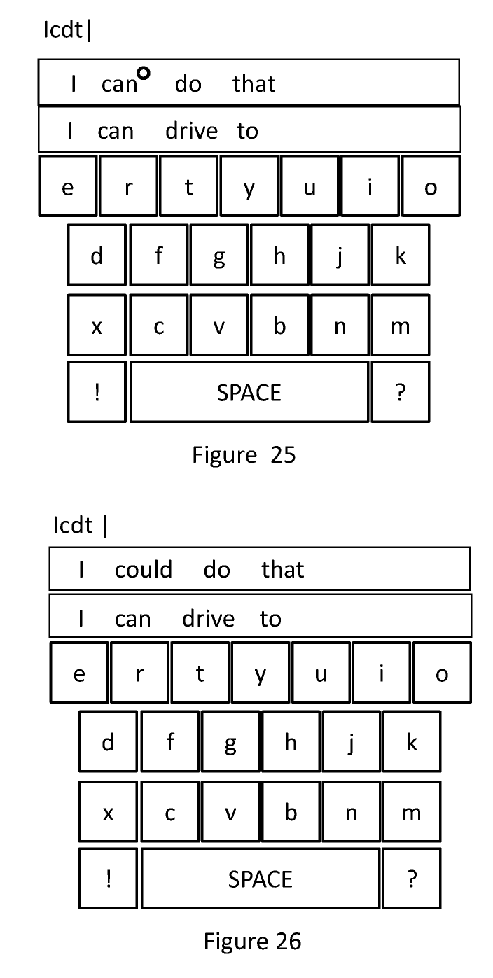

In some embodiments, instead of entering the suggestion in its alternative form, the electronic device processor just changes the suggestion to its alternative form and the user has to tap on the suggestion again to enter it. This will be useful in cases that the user wants to change multiple words of the sequence (e.g., the user wants to enter “You can eat my apples too”, but the electronic device has suggested “You could eat my apple too”). In FIG. 25, the user has inputted “Icdt” and the electronic device is displaying two sequences of words. The user wanted to enter “I could do that”. Thus, the user has long pressed (indicated by a hollow dot) “can” on the top row. In response, the electronic device changes “can” to “could” (see FIG. 26).

Finding the past or present form of a verb can be done for example using grammar rules and a secondary database (such as database 170 shown in FIG. 4) that has information about irregular verbs. Similarly, the singular and plural forms of names can be found for example using grammar rules and a secondary database that has information about exceptions.

In some embodiments, the electronic device has a secondary database that includes one or more pairs of words. When the user indicates she wants to change a word, the electronic device processor searches the secondary database and if the word exists in one of the pairs, the electronic device processor replaces the displayed word with the other word of the pair. For example, the electronic device might have the following pair <“his”, “her”> in its database. If the user long presses “his” in the “I saw his car” sequence, the electronic device processor changes the sequence to “I saw her car”.

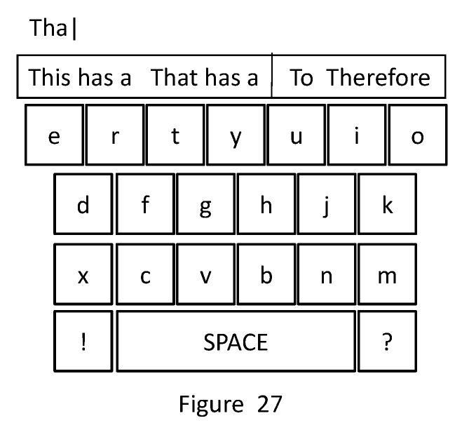

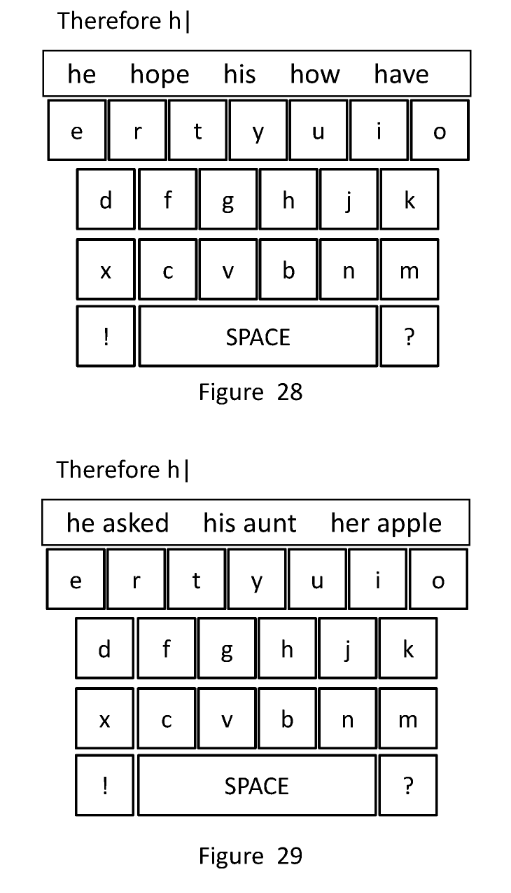

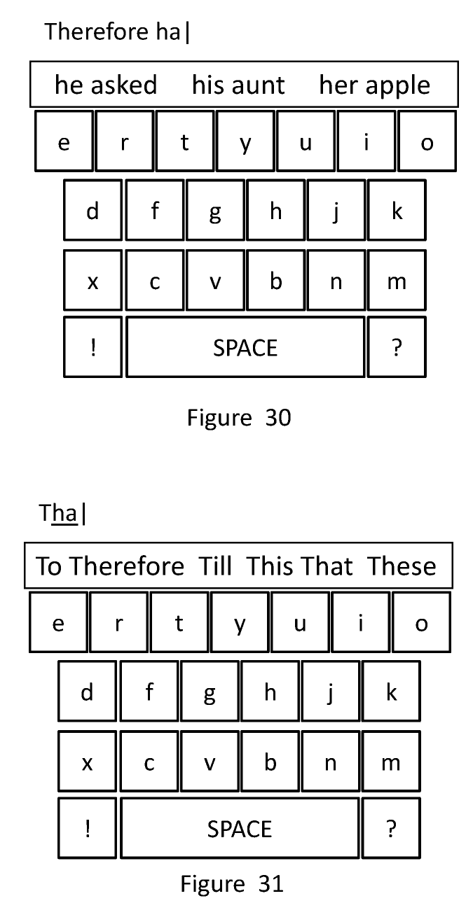

If the user does not find what she wants to enter among the multi-word suggestions, it is necessary to provide a way for her to enter what she wants. In some embodiments, several words starting with the first letter input by the user (i.e., word completion suggestions or single word suggestions) are displayed on the suggestion bar for the user to select. The user can select and enter one of them by tapping on the word. In some embodiments, the single word suggestions are displayed, on a scrollable suggestion bar, after the multi-word suggestions. This way, the user will see them after finishing viewing multi-word suggestions and without scrolling back to the beginning of the suggestion bar. This is specially useful on a smartwatch since due to the screen size limitation, the user has to scroll the suggestion bar to see all suggestions. FIG. 27 illustrates one such embodiment. FIG. 28 illustrates an embodiment in which, after entering one of the single word suggestions, the electronic device processor inserts a space and displays the second letter previously input by the user to make it easier for the user to continue typing. In some embodiments, as shown in FIG. 28, after entering the word, the electronic device processor inserts a space and displays the second letter previously input by the user and one or more words, each word starting with the second letter and displays them on the suggestion bar. In some embodiments, as shown in FIG. 29, the electronic device displays one or more multi-words, each multi-word found using k consecutive letters previously input by the user, where k is at least 2 and the sequence of consecutive letters starts with the second letter of the n-letter sequence. In some embodiments, as shown in FIG. 30, after entering one of the single word suggestions, the electronic device processor inserts a space and displays multiple consecutive letters previously input by the user. The sequence of consecutive letters starts with the second letter of the n letters previously input by the user.

If what the user wants to input is not among the multi-word and single word suggestions, then, the user has to erase n−1 letters that she has input (i.e., keep only the first letter, which is the first letter of the first word she wants to enter) and type other letters of the first word she wants to enter. In some embodiments, pressing a button or performing a gesture deletes the last n−1 letters so the user can input the second letter of the first word. In some embodiments, if the user scrolls past the multi-word suggestions or starts viewing single word suggestions, and inputs a character, the electronic device processor knows that the user didn't find what she wanted to enter, thus, the first n−1 letters are erased and the character is written after the first letter. In some embodiments, if the user scrolls past the multi-word suggestions or starts viewing single word suggestions, the electronic device processor highlights the last n−1 letters. This may be indicated by changing the background color for those letters, underlining those letters, changing the font color of those letters, or any other means, as illustrated in FIG. 31. If the user inputs a new character, those letters are erased and the new character is displayed after the first letter. In some embodiments, if the user scrolls back to see the multi-word suggestions on the suggestion bar, the selected letters are deselected. Thus, if the user inputs a character, it is displayed after the already input n-letter sequence.

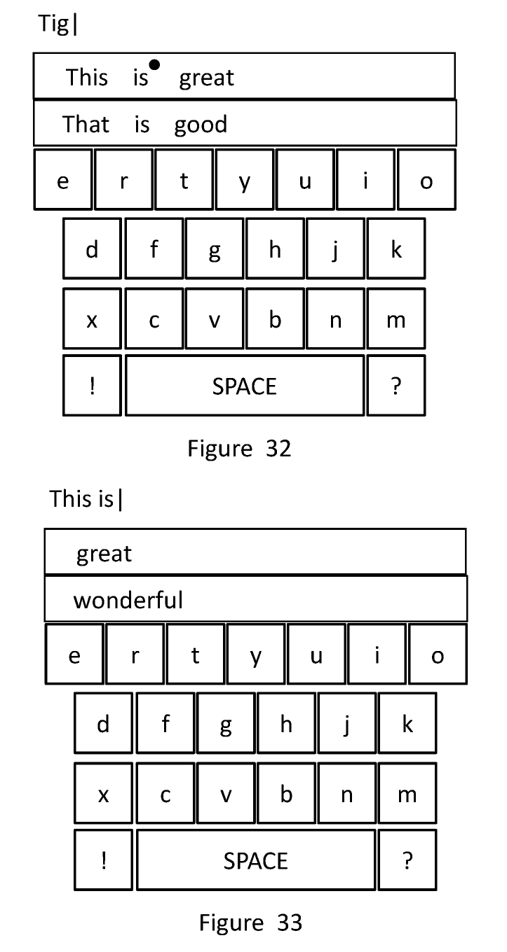

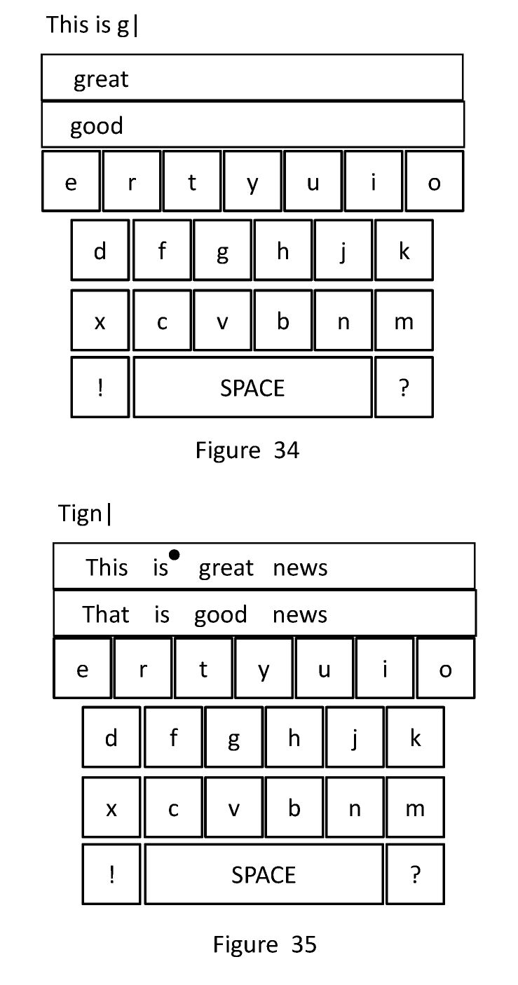

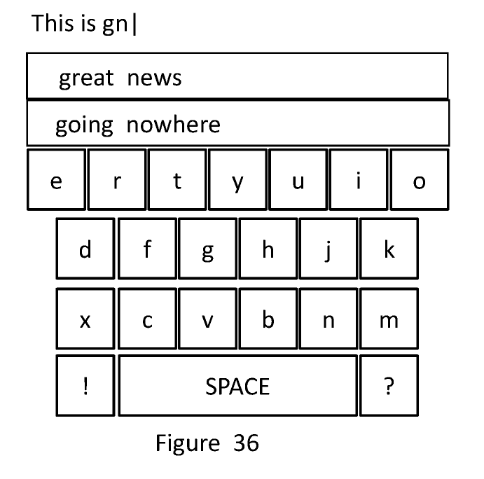

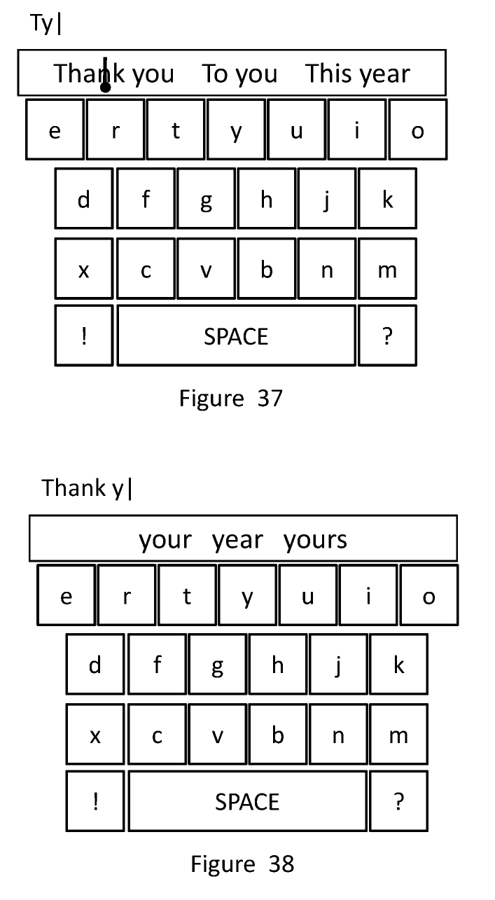

In some embodiments, the user can enter a part of a multi-word suggestion instead of the entire suggestion. In FIG. 32, the user has inputted “Tig”. The electronic device is displaying two multi-word suggestions and the user has tapped on “is” in the top row to enter “This is”. In FIG. 33, the electronic device processor has erased “g” and has suggested two words as the next words the user wants to enter. In some embodiments, after entering K words, 0<K<M, the electronic device processor inserts a space and inserts the first letter of the K-th word. For example, if the user enters “This is”, the electronic device inserts a space and inserts “g” (FIG. 34). In some embodiments, after entering K words, 0<K<M, the electronic device processor inserts a space and inserts the last (M-K) letters inputted by the user. In FIG. 35, the user has inputted “Tign” and has tapped on “is” on the top row. In response, the electronic device enters “This is”, inserts a space after it, and writes “gn” after the space and displays two sequences of words (FIG. 36). This is useful when the electronic device processor cannot correctly predict all the words the user wants to enter. In some embodiments, by tapping on a word of a multi-word suggestion, the user enters all the words of the multi-word suggestion except the words after the tapped word. In some embodiments, tapping anywhere on the multi-word suggestion enters all the words of the multi-word suggestion, but performing a gesture such as swiping a finger (i.e., dragging a finger) upward on one of the words, enters all the words of the multi-word suggestion except the words after the swiped word. This makes it easier to use the electronic device for the common case of entering all words because the user can enter all words if she taps anywhere on the multi-word suggestion. In FIG. 37, the user has inputted “ty” and the electronic device processor has suggested multiple sequences of words including “Thank you”. The user has swiped her finger on the word “Thank”, thus, the electronic device enters the word “Thank” inserts a space after it and displays letter “y” after the space and suggests multiple words starting with “y” (FIG. 38).

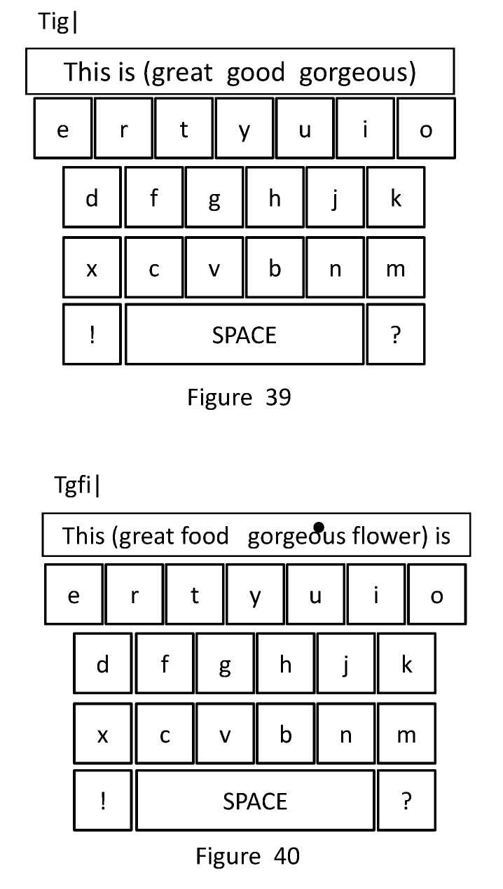

To better display several multi-word suggestions on a small screen, the electronic device processor might combine several multi-word suggestions and display them together. In some embodiments, if several multi-word suggestions differ in one or more consecutive words, the differences are displayed together and the remaining words are displayed only once. The user can enter one of the multi-words by performing a gesture. In some embodiments, illustrated in FIGS. 39 and 40, the gesture is performed on one of the differences. In FIG. 40, the user wants to enter “This gorgeous flower is” so she taps on “gorgeous flower”.

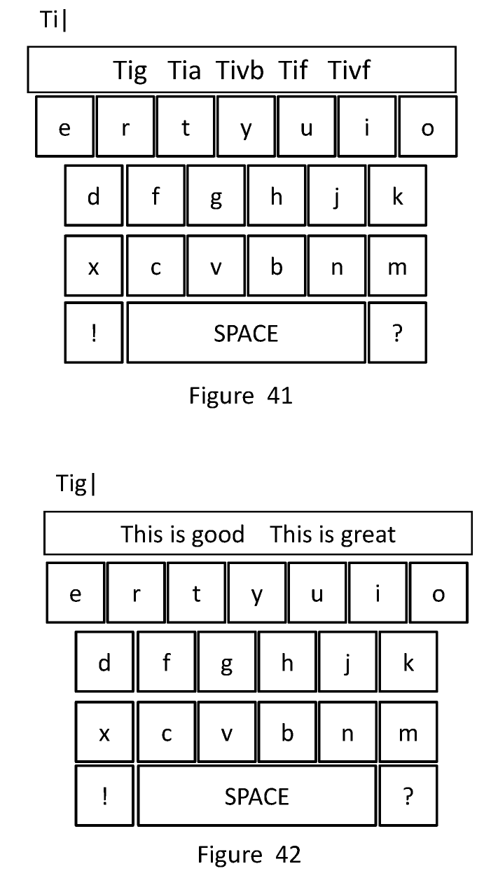

To teach novice users what keys (in the n-gram table) are available for her to use or to better display information on a small screen, in some embodiments, as the user inputs the letters, the electronic device displays one or more completion for the sequence of letters chosen from the keys in the n-gram tables. This is illustrated in FIG. 41. Note that displaying the keys is easier than displaying the multi-word suggestions, especially on a small screen. If the user selects one of the completions, the electronic device displays one or more multi-word suggestions corresponding to that key on the suggestion bar. In some embodiments, the user can select one of the completions (keys) to enter it and the electronic device displays one or more multi-word suggestions corresponding to the key on the suggestion bar. In FIG. 41, the user has entered “Ti” and the electronic device has displayed several completions, including “Tig”. If the user taps on “Tig”, the electronic device enters “Tig” and displays several multi-word suggestions corresponding to “Tig” (FIG. 42).

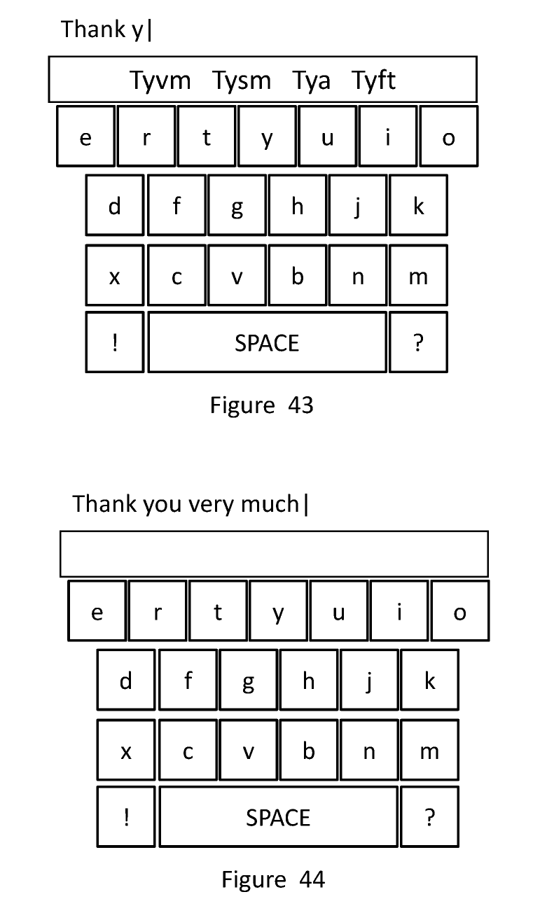

To teach and encourage users to use the new invention, in some embodiments, as the user enters words using the keyboard and possibly using the regular single word suggestions, the electronic device displays one or more sequence of letters, chosen from the keys in the n-gram tables, such that the first k words of the sequence are the same as the last k words the user has entered or is entering (see FIG. 43) (Note that displaying the keys is easier than displaying the multi-word suggestions corresponding to the keys specially on a small screen. Additionally, one objective is to teach the user what keys are available for her to use). If the user selects one of the keys, the electronic device displays one or more multi-word suggestions corresponding to the key on the suggestion bar. In some embodiments, the user can input a multi-word suggestion by tapping on its corresponding sequence of letters (key) and the multi-word suggestion replaces the last k words she has input or is inputting (as shown in FIG. 44).

In some embodiments, the letters are input using a physical keyboard. In some embodiments, the letters are input using a virtual keyboard. In some embodiments, the letters are input using a QWERTY keyboard. In some embodiments, the letters are input using a gesture based technique such as Swype™. In some embodiments, the letters are input using voice recognition. In some embodiments, the letters are input by writing them and the electronic device uses handwriting character recognition to detect the letters.

In some embodiments, error correction techniques are used to correct a sequence of erroneous letters input by the user before finding one or more sequences of words. The error correction can be based on the coordinates of touch points (the points on the touch screen the user has touched), the location of keys on the keyboard, and a database of valid sequence of letters or keys. In some embodiments, there is a frequency associated to each sequence in the database, the higher the frequency, the more likely the user enter that sequence, and the frequencies are used when correcting errors.

In some embodiments, the letters are input using a keypad and there are multiple letters corresponding to each key. For example, “A”, “B”, and “C” might correspond to the second key of the keypad. The user presses the key once to input “A”, twice to input “B”, and three times to input “C”. The electronic device detects that the user has finished inputting the character if a threshold time since the first time the key was pressed has passed or a threshold time since the last time the key was pressed has passed or if the user has pressed another key.

In some embodiments, the letters are input using a keypad and there are multiple letters corresponding to each key. For example, “A”, “B”, and “C” might correspond to the second key of the keypad. The user presses the key once to input any of “A”, “B”, or “C”. Similarly, the third key might correspond to letters “D”, “E”, and “F”. If the user presses the second key and then presses the third key, the electronic device processor finds all word sequences corresponding to “AD”, “AE”, “AF”, “BD”, “BE”, and “BF” and displays one or more of them to the user as the suggested sequence of words.

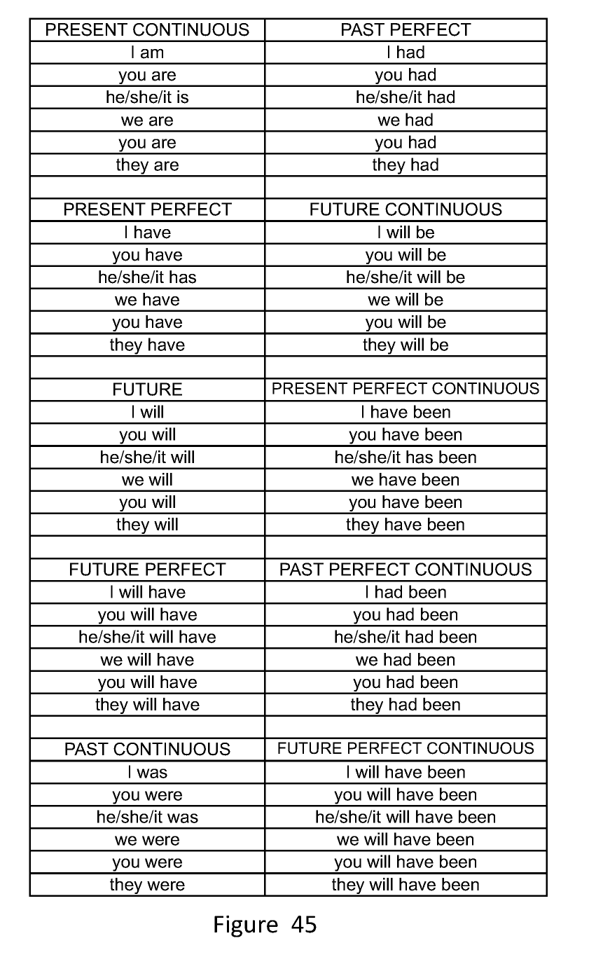

Consider the table shown in FIG. 45. In some embodiments, the n-gram tables contain some or all of the sequences shown in the figure (e.g., “I am”, “I will have been”). These sequences are used when conjugating verbs in English language. Thus, they are frequently used. Additionally, users can easily remember that they are included in the n-gram table, thus, they can be entered by inputting the first letters of their words.

In some embodiments, the n-gram tables contain some or all of the sequences in FIG. 45 in the negative form (e.g., “I am not”, “I will not have been”).

In some embodiments, the n-gram tables contain some or all of the sequences in FIG. 45 in the interrogative form (e.g., “am I”, “will I have been”).

In some embodiments, the n-gram tables contain some or all of the sequences in FIG. 45 in the negative interrogative form (e.g., “am I not”, “will I not have been”).

In some embodiments, the n-gram tables contain some or all of the sequences in FIG. 45 in the contracted negative form (e.g., “you aren't”, “aren't you”).

Scrolling the suggestion bar can be difficult on a small screen and the user might touch other elements displayed on the screen by mistake. In some embodiments, if the user has not performed any actions within a certain period of time, the scroll bar scrolls automatically to show other suggestions to the user.

In some embodiments, the electronic device displays both correction suggestions and completion suggestions, but in two different regions on the suggestion bar and the electronic device is initialized to display the middle of the scrollable suggestion bar such that a part of each region is visible. This makes it easier for the user to look at the suggestions without the need to scroll from the beginning of the suggestion bar.

In some embodiments, instead of multiple n-gram tables, there is a single table (database). For example, bigrams, trigrams, 4-grams and 5-grams (i.e., 2-word, 3-word, 4-word, and 5-word sequences) are stored in a single table.

In some embodiments, if the user has input K letters, K>=2, the electronic device processor searches all n-gram tables to find a sequence of K words, whose first letters are the same as the letters input by the user. For example, if the user has input “tar”, the electronic device processor searches trigram table, 4-gram table, etc.

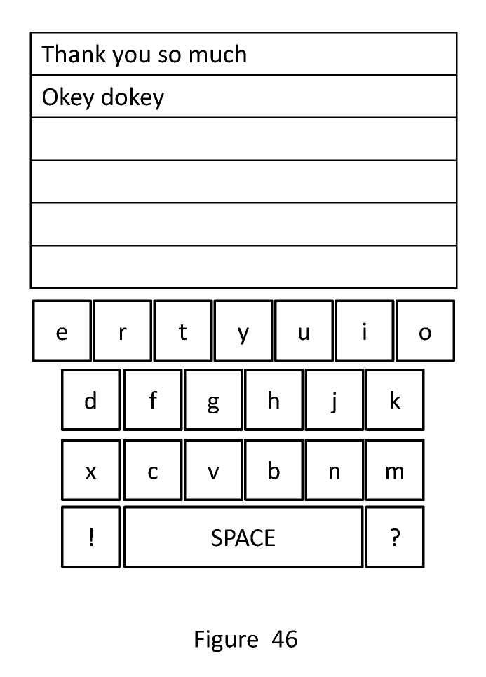

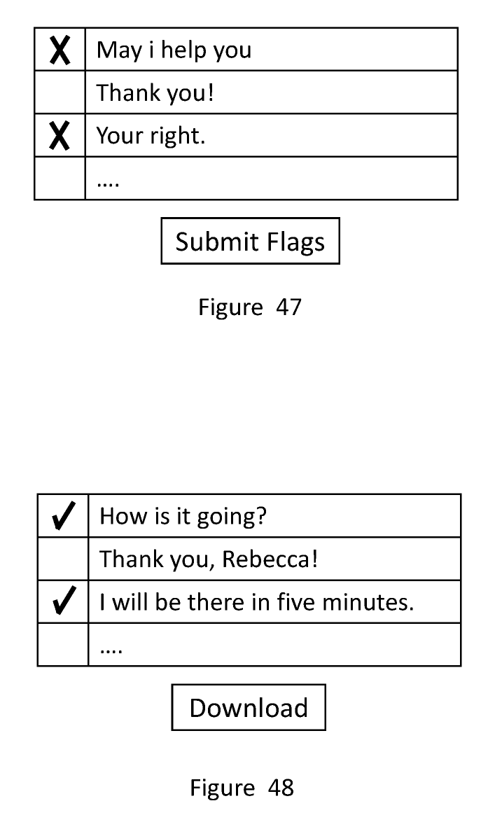

In some embodiments, the electronic device has a user interface as shown in FIG. 46, that allows the user to enter a sentence or a sequence of words and add it to the database of the electronic device. The user can also delete a sentence or a sequence of words from the database of the electronic device. This can be very useful especially for languages for which a good set of n-grams is not available. In some embodiments, the user can submit the sentences or the sequence of words that she enters to share them with other users. In some embodiments, a user can use the sentences or the sequence of words submitted by others only if she has submitted some sentences or sequence of words. In some embodiments, the electronic device has a user interface that allows a user to review submitted sentences or sequences of words and flag the ones which are not appropriate (e.g., grammatically wrong or offensive) or choose which ones he wants to download and add to his database (or n-gram tables) (FIGS. 47 and 48). In some embodiments, the electronic device processor selects some sentences or sequences of words existing in the user database (e.g., added explicitly by the user using the user interface or added because it was part of a text received or sent by the user or written by the user) and asks user's permission to submit them and share them with others. In some embodiments, the selection is done by filtering out sentences or sequences of words that contain, words not existing in the dictionary of the language used by the user, proper nouns, or offensive words. In some embodiments, the selection for filtering takes into account the usage frequency of the sequence of words.

In some embodiments, if a word starts with non-letter characters (e.g., “#”, “3” or “ [symbol] ”), the first letter character is used when constructing a key for the sequence of words. If there is no letter character in the string, the first character is used. For example, if the user has previously input “#soccercup #finalmatch” and an entry corresponding to it has been added to the database, if the user inputs “sf”, the electronic device processor may suggest “#soccercup #finalmatch”.

As another example, if “ [symbol] Cuántos años tienes?” has been added to the database, if the user inputs, “cat”, the electronic device processor suggests “ [symbol] Cuántos años tienes?”.

In some embodiments, some characters are ignored when generating keys. For example, “#” and “@” are ignored. Thus, if a user has entered “#soccercup #2016”, the electronic device processor generates “s2” as the key for the entry.

In some embodiments, some non-words are included in the database of the electronic device. For example, the database might have “U.S. Route 101”. If the user enters “ur1”, the electronic device processor suggests “U.S. Route 101”.

In some embodiments, if the key has accented letters, when searching the table for finding a matching key, the accents may be ignored. For example, if the key of an entry is “ádm” and the user has input “adm”, the electronic device processor returns the entry corresponding to “ádm” and suggests it to the user.

In some embodiments, the electronic device processor considers a hyphenated word as multiple words. Thus, if the user has previously entered “up-to-date account” and it's been added to the database, if the user enters “utda”, the electronic device processor suggests “up-to-date account”. In some embodiments, the electronic device processor does not consider a hyphenated word as multiple words. Thus, if the user enters “ua”, the electronic device processor suggests “up-to-date account”.

In some embodiments, a list of words or non-words (strings) exists in the database of the electronic device. The items of the list might be separated with, for example, comma, “and”, “or”, or “and/or”. The electronic device processor considers all permutations of the items of the list when searching the database for a key and if there is a match, the electronic device processor permutes the items before suggesting them to the user. For example, “Jack, Mary, Alex” is in the database, if the user enters “mja”, the electronic device processor suggests “Mary, Jack, Alex”. As another example, if “Jack and Mary” is in the database, if the user enters “maj”, the electronic device processor suggests “Mary and Jack”.

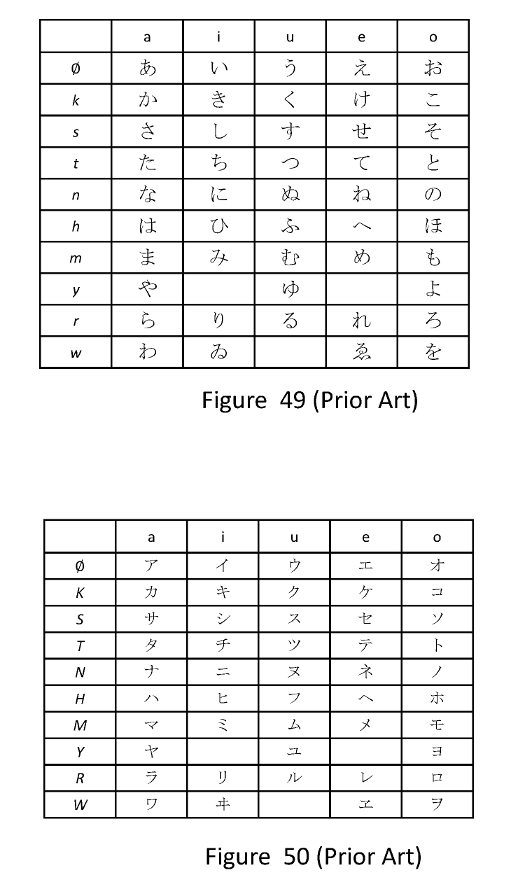

In some keyboards, users can type in English to input Japanese Hiragana, Katakana, or Kanji characters. For example, a user may input “ka” using English letters and the keyboard converts it to “ [symbol] ”, which is a Hiragana character (FIG. 49 shows how the English letters are mapped to Hiragana characters. To input the characters of the first row, the user inputs only the vowel). Alternatively, the keyboard may convert “ka” to “ [symbol] ”, which is a Katakana character or suggest it to the user (FIG. 50 shows how the English letters are mapped to Katakana characters. To input the characters of the first row, the user inputs only the vowel). As another alternative, the keyboard may convert the English letters to a Kanji character (i.e., the user can input the pronunciation of a Kanji character using English letters and the keyboard suggests one or more Kanji characters whose pronunciation is the same as what the user has input. For example, if the user inputs “tano”, the keyboard might convert it to or suggest “ [symbol] ”).

In some embodiments of the current invention, the electronic device is used to enter sentences or words in Japanese. The electronic device has a database of multiple words or sentences in Katakana, Hiragana or Kanji. For a given entry, for each Katakana or Hiragana character, the electronic device processor finds its corresponding English letters using tables in FIGS. 49 and 50, and for each Kanji character, it finds its pronunciation written in English. The electronic device processor generates a key for the entry by taking the letters corresponding to the first character of each Katakana, Hiragana or Kanji word. A user can enter a given sequence of words or a sentence in Japanese by inputting English letters corresponding to the first character of each word. In some embodiments, the electronic device processor generates a key for the entry by taking the first letter corresponding to the first character of each Katakana, Hiragana or Kanji word. A user can enter a given sequence of words or a sentence in Japanese by inputting English letter corresponding to the first character of each word. In some embodiments, the electronic device processor generates a key for the entry by taking the first letter corresponding to each character of each Katakana, Hiragana or Kanji word. A user can enter a given sequence of words or a sentence in Japanese by inputting the first English letter corresponding to each character of each word. In some embodiments, each entry has a single word and the electronic device processor generates a key for the entry by taking the first English letter corresponding to each character of the Katakana, Hiragana or Kanji word. A user can enter the word in Japanese by inputting the first English letter corresponding to each character of the word.

In some keyboards, Katakana or Hiragana characters can be input directly. They can also convert the input characters to Kanji characters or suggest some Kanji characters or words to the user. For example, they may convert “ [symbol] ” to “ [symbol] ”.

In some embodiments, the electronic device has a database of multiple-words or sentences in Katakana, Hiragana or Kanji. For a given entry, for each Kanji character, it finds its corresponding characters in Katakana or Hiragana. The electronic device processor generates a key for the entry by taking the first character of each Katakana or Hiragana word or by taking all Katakana or Hiragana characters corresponding to the first Kanji character of each word. A user can enter a given sequence of words or a sentence in Japanese by inputting Katakana or Hiragana characters corresponding to the first character of each Katakana or Hiragana word or by taking all Katakana or Hiragana characters corresponding to the first Kanji character of each word. In some embodiments, the key is generated by taking the characters corresponding to the first character of each Katakana or Hiragana word or by taking the first Katakana or Hiragana character corresponding to the first Kanji character of each word. A user can enter a given sequence of words or a sentence in Japanese by inputting Katakana or Hiragana characters corresponding to the first character of each Katakana or Hiragana word or the first Katakana or Hiragana character corresponding to the first Kanji character of each word. In some embodiments, the key is generated by taking the characters corresponding to the first character of each Katakana or Hiragana word or by taking the first Katakana or Hiragana character corresponding to each Kanji character of each word. A user can enter a given sequence of words or a sentence in Japanese by inputting Katakana or Hiragana characters corresponding to the first character of each Katakana or Hiragana word or the first Katakana or Hiragana character corresponding to each Kanji character of each word.

In some embodiments, the electronic device is used for entering a Kanji word. There are one or more Kanji words in the database of the electronic device. The electronic device processor generates a key for each entry, i.e., for each Kanji word, by taking the first Katakana or Hiragana character corresponding to each Kanji character of the word. The user can input a Kanji word by inputting the first Katakana or Hiragana character corresponding to each of its Kanji characters.

In Korean language, letters are stacked into blocks of letters. Each block has between 2 to 5 letters. Each word consists of one or more blocks. In some embodiments, the database of the electronic device has one or more entries written in Korean language. Each entry has two or more words. The key corresponding to each entry is constructed by taking the first block of each word. If a user inputs multiple blocks of letters in Korean language, the electronic device processor searches the database to find the entry corresponding to the input blocks of letters and displays it as a suggestion to the user. In some embodiments, the key of each entry is generated by taking the first letter of the first block of each word. In some embodiments, the electronic device processor generates the key of each entry by taking the first and the second letter of the first block of each word. In some embodiments, the electronic device processor generates the key of each entry by taking the first letter of each block of each word. In some embodiments, the electronic device processor generates the key of each entry by taking the first and the second letters of each block of each word. In some embodiments, some entries have only a single word and the word has at least two blocks of characters, and the electronic device processor generates the key of each entry by taking the first letter of each block of the word. The user can enter the word by entering the first letter of each block of the word. In some embodiments, some entries have only a single word and the word has at least two blocks of characters, and the electronic device processor generates the key of each entry by taking the first and the second letters of each block of the word. The user can enter the word by inputting the first and the second letters of each block of the word.

In Korean language, in some cases, a space is not used between words. In some embodiments, the electronic device processor considers such words as a single word when finding the key corresponding to an entry using one of the before mentioned techniques.

In some keyboards, Pinyin or a similar method is used to input Chinese characters. The user inputs the pronunciation of the Chinese characters using English letters (or letters in another language). The keyboard suggests one or more Chinese characters based on the pronunciation input by the user.

In some embodiments, the electronic device is used to enter multiple words or a sentence in Chinese language. The electronic device has a database which includes one or more entries written in Chinese language. For each entry the electronic device processor generates a string of characters using the pronunciation of each Chinese character written using English letters (or letters of another language). For each entry, a key is generated by taking the first letter of the pronunciation of each Chinese character. In some embodiments, the key is generated by taking the first n letters of the pronunciation of each Chinese character, where n is an integer greater than 1. In some embodiments, a key is generated by taking the first letter of the pronunciation of the first Chinese character of each word. In some embodiments, the key is generated by taking the first n letters of the pronunciation of the first Chinese character of each word, where n is an integer greater than 1. In some embodiments, the key is generated by taking all letters of the pronunciation of the first Chinese character of each word. In some embodiments, the key is generated by taking the first Chinese character of each word, and the user inputs multiple Chinese characters corresponding to the first character of each word and the electronic device processor suggests multiple Chinese words. In some embodiments, some entries have a single word and the word has at least two Chinese characters and the key is generated by taking the first n letters of the pronunciation of each Chinese character, where n is a positive integer. The user can enter the Chinese word, by inputting the first n letters of the pronunciation of each of its Chinese characters. In some embodiments, n is greater than 1.

In some embodiments, the electronic device has a database which has one or more entries. Each entry has n strings or words, where n>1. The electronic device processor generates a representation of each entry by converting each string or word into a second string such that a user can enter the original string or word by inputting the second string using the input device of the electronic device. This results in a set of n new strings corresponding to the entry. The electronic device processor generates a key corresponding to the entry by taking k characters of each of n new strings. In response to inputting these k*n characters by the user, the electronic device processor suggests the n strings (original strings) or words of the corresponding entry to the user. In some embodiments, k is 1. In some embodiments, the k characters are the first k characters of the string. In some embodiments, the representation of the entry is in a different alphabet or language than the original n string or words. In some embodiments, the electronic device processor generates a key corresponding to the entry by taking k characters from the representation of each character of the original entry, where k>=1 and the original entry and the representation are in two different alphabets or languages.

In the above invention, instead of displaying the suggestions on a suggestion bar, it is possible to enter one of them automatically. It is also possible to enter one of them automatically and display other suggestions on the suggestion bar so the user can choose one of them to replace the automatically entered suggestion.

Note: figures show only a portion of a keyboard.

In most cases, instead of a virtual keyboard a physical keyboard can be used to use this invention.

In the above invention, the electronic device processor might generate more than one key for a given entry. Thus, if the user inputs any of those keys, the electronic device processor will suggest the corresponding entry to the key (e.g., one of the words of the multiple-word starts with a non-letter).

In the above invention, the suggestions can be displayed on a touch screen and the user can select them by, for example, tapping on the suggestion.

Embodiments described herein provide various benefits. More specifically, embodiments predict or suggest words in ways that speed up data entry for the user. One particular benefit is in reducing the frequency at which the user is required to switch attention back and forth between typing characters and selecting the desired word or words. Another advantage is improving the prediction accuracy by using information about multiple successive words when suggesting words to the user. Some embodiments accumulate knowledge of the user's habitual vocabulary to improve the prediction accuracy.

Embodiments of the present invention may be implemented by using a non-transitory storage medium storing instructions executable by one or more processors to facilitate data entry by carrying out any of the methods described herein.

The above-described embodiments should be considered as examples of the present invention, rather than as limiting the scope of the invention. Various modifications of the above-described embodiments of the present invention will become apparent to those skilled in the art from the foregoing description and accompanying drawings. Accordingly, the present invention is to be limited solely by the scope of the following claims.

1. An electronic device configured to facilitate data entry, the electronic device comprising:
a processor;
a display;
a database of n-grams; and
an input device;
wherein in response to receiving as input into the input device a sequence of M letters, where M is greater than or equal to 2, and each of the M letters corresponds to the first letter of a word, the processor extracts from the n-gram database one or more sequences of M words, each of the M words in each sequence beginning with a corresponding one of the M input letters, and displays the one or more sequences of M words on the display; and
wherein in response to a selection being made from the displayed sequences of a sequence of K words starting at the beginning of one of the sequences of M words, where K is less than or equal to M, the processor replaces the first K letters of the sequence of M letters by the selected sequence of K words, the processor accepts the selected sequence of K words as desired data entry into the device.

2. The electronic device of claim 1 wherein K<M.

3. The electronic device of claim 1 wherein in response to receiving as input into the input device a sequence of M letters, one or more single words that start with the M letters are displayed in addition to the one or more sequences of words extracted from the n-gram database.

4. The electronic device of claim 1 wherein the processor selects which one or more sequences of words to extract from the n-gram database to display based at least in part on occurrence frequencies associated with corresponding n-gram sequences as recorded in the n-gram database.

5. The electronic device of claim 1 wherein the processor records at least one of the number of times a particular sequence of words has been selected as desired data entry or the last time a particular sequence of words was selected as desired data entry, and uses the record in selecting which one or more sequences of words to extract from the n-gram database to display in subsequent use of the electronic device.

6. The electronic device of claim 1 wherein the input device is a keyboard.

7. The electronic device of claim 1 wherein the keyboard is a virtual keyboard supporting gesture-based data entry.

8. The electronic device of claim 1 wherein the processor stores in the n-gram database a sentence or a sequence of words previously entered into the device, such that at least a part of the sentence or the sequence of words is available for extraction and display in subsequent use of the electronic device.

9. The electronic device of claim 1 wherein the processor stores in the n-gram database a sentence or a sequence of words previously received by the device such that at least a part of the sentence or the sequence of words is available for extraction and display in subsequent use of the electronic device.

10. The electronic device of claim 1 additionally comprising a button operatively connected to the processor and display such that pressing the button deletes all input letters except the first letter of the input sequence.

11. The electronic device of claim 1 wherein in response to receiving input comprising long pressing or swiping an extracted displayed word, the processor searches the database for a pair of words including the extracted displayed word and replaces the extracted displayed word with the other word of the pair.

12. The electronic device of claim 1 further comprising a secondary database of valid words; wherein the display includes a scrollable suggestion bar with a first region on which the extracted sequences of M words are displayed and a second region on which one or more single words, extracted by the processor from the secondary database of valid words, are displayed, each of the single words beginning with the first input letter.

13. The electronic device of claim 1 wherein in response to receiving as input into the input device one or more words before receiving as input into the input device the sequence of M letters, the processor enters the one or more words, and uses the one or more entered words when, in response to receiving as input into the input device the sequence of M letters, selecting the sequences of M words to extract from the n-gram database and display.

14. A method of facilitating data entry, the method comprising:
receiving textual input comprising a sequence of M letters, where M is greater than or equal to 2, and each of the M letters corresponds to the first letter of a word;
in response to the textual input, extracting from an n-gram database one or more sequences of M words, each of the words in each sequence beginning with a corresponding one of the M input letters;
displaying the one or more extracted sequences of M words on a display; and
in response to a selection of a sequence of K words starting at the beginning of one of the sequences of M words, where K is less than or equal to M, replacing the first K letters of the sequence of M letters by the selected sequence of K words, and accepting the selected sequence of K words as desired data entry.

15. The method of claim 14 wherein the choice of which one or more sequences of words is extracted from the n-gram database for display is based at least in part on occurrence frequencies associated with corresponding n-gram sequences as recorded in the n-gram database.

16. The method of claim 14 wherein the textual input is received by a keyboard.

17. The method of claim 14 further comprising, in response to receiving textual input of one or more words before receiving textual input of a sequence of M letters, entering the one or more words, and using the one or more entered words when selecting the sequences of M words to extract from the n-gram database and display.

18. A method of facilitating data entry, the method comprising:
receiving textual input, either using a first data entry method wherein the textual input comprises a sequence of M letters, where M is greater than or equal to 2, and each of the M letters corresponds to the first letter of a word; or using a second data entry method wherein the second data entry method is different than the first data entry method and the textual input comprises one or more letters that begin a single word; or both;
in response to receiving textual input using the first data entry method, extracting from an n-gram database one or more sequences of words, each of the words in each sequence beginning with a corresponding one of the M input letters, displaying the extracted sequences, and, in response to a selection of a sequence of M words, accepting the selected sequence of M words as desired data entry; and
in response to receiving textual input using the second data entry method, extracting from a word database one or more words starting with the one or more letters input using the second data entry method, displaying the extracted one or more words, and, in response to a selection of one of the one or more displayed words, accepting the selected word as desired data entry.

19. The method of claim 18 wherein the first method of data entry is a gesture based method and letters are input by moving a finger or stylus on a virtual keyboard.

20. The method of claim 18 wherein the second method of data entry is standard keyboard typing.
